(19) United States
(12) Patent Application Publication
(10) Pub. No.: US 2026/0116278 A1
(43) Pub. Date: Apr. 30, 2026

(54) FRAMES FOR SUPPORTING A SEATBACK BOLSTER OF A VEHICLE

(71) Applicant: Toyota Motor Engineering & Manufacturing North America, Inc., Plano, TX (US)

(72) Inventors: Tiffany M. Sontag, Milan, MI (US); Ryan M. Mahn, Lambertville, MI (US); Mark D. Clauser, Saline, MI (US); Jennifer D. Short, Libertyville, IL (US); Daniel G. Shriver, Ann Arbor, MI (US); Mitchell J. Gerczak, Ann Arbor, MI (US); Juliana M. Said, Chelsea, MI (US); Yi-Ru C. Sosnowski, Ann Arbor, MI (US); James Sontag, Milan, MI (US)

(73) Assignees: Toyota Motor Engineering & Manufacturing North America, Inc., Plano, TX (US); Toyota Jidosha Kabushiki Kaisha, Aichi-Ken (JP)

(21) Appl. No.: 18/932,876

(22) Filed: Oct. 31, 2024

(51) Int. Cl. B60N 2/68; B60R 22/26

(52) U.S. Cl. CPC B60N 2/688; B60R 22/26; B60R 2022/266

(57) ABSTRACT

A frame for supporting a seatback bolster of a vehicle includes a first bracket having a mounting section configured to be fixed to a chassis of the vehicle, and an interface section extending from the mounting section away from the chassis. The frame further includes a second bracket configured to be at least partially disposed within and mounted to the seatback bolster. The frame further includes a fastener that engages the interface section of the first bracket and the second bracket to fix the first bracket with the second bracket.

### TECHNICAL FIELD

The present specification generally relates to frames for supporting a seatback bolster of a vehicle and, more specifically, frames for supporting a seatback bolster having a belt guide mounted thereto for use with a seatbelt.

### BACKGROUND

Seatbelts utilized in vehicles commonly provide a belt guide that provides an aperture through which webbing of the seatbelt is disposed. The belt guide is traditionally positioned near a shoulder of an occupant. In some applications, the belt guide is mounted to a seatback bolster, which forms an edge of the seatback that supports the occupant in a lateral direction across the vehicle. Seatback bolsters commonly utilize a hook and latch mechanism to couple the seatback bolster to a chassis of the vehicle. The hook and latch mechanism allows for quick assembly of the seatback bolster to the chassis by moving the hook around the latch to couple the seatback bolster. The belt guide is in-turn mounted to the hook and latch mechanism. While useful during assembly, the hook and latch mechanism is susceptible to deflection when the belt guide becomes loaded during a vehicle event (such as a collision). The deflection of the hook and latch mechanism and the subsequent movement of the belt guide causes the seatbelt to move in the lateral direction, which in-turn causes the seatbelt to slide up the occupant's chest and not achieve a desired belt position target for ideal occupant restraint.

Accordingly, a need exists for alternative frames for supporting a seatback bolster of a vehicle.

### SUMMARY

In one embodiment, a frame for supporting a seatback bolster of a vehicle includes a first bracket having a mounting section configured to be fixed to a chassis of the vehicle, and an interface section extending from the mounting section away from the chassis. The frame further includes a second bracket configured to be at least partially disposed within and mounted to the seatback bolster. The frame further includes a fastener that engages the interface section of the first bracket and the second bracket to fix the first bracket with the second bracket.

In another embodiment, a support assembly for a seatback bolster and a seatbelt of a vehicle includes a frame having a mounting section configured to be fixed to a chassis of the vehicle and an attachment section fixed to the mounting section and configured to be at least partially disposed within and mounted to the seatback bolster for supporting the seatback bolster relative to the chassis. The support assembly further includes a belt guide defining an aperture for retaining the seatbelt therein and guiding movement of the seatbelt, wherein the belt guide is fixed to the attachment section of the frame.

In yet another embodiment, a seatback bolster assembly for a vehicle includes a frame having a mounting section configured to be fixed to a chassis of the vehicle and an attachment section fixed to the mounting section. The seatback bolster assembly further includes a seatback bolster having an external surface configured to support an occupant of the vehicle and an internal surface, disposed opposite the external surface, and defining a cavity. The attachment section is at least partially disposed within the cavity and mounted to the internal surface of the seatback bolster for supporting the seatback bolster relative to the chassis. The seatback bolster assembly further includes a belt guide defining an aperture for retaining a seatbelt therein and guiding movement of the seatbelt, wherein the belt guide is disposed on the external surface of the seatback bolster and is fixed to the attachment section of the frame through the seatback bolster.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a vehicle having a seatbelt and a seatback bolster assembly, according to one or more embodiments shown and described herein;

FIG. 2 schematically depicts a perspective view of the seatback bolster assembly of FIG. 1, having a seatback bolster, a frame, and a belt guide, according to one or more embodiments shown and described herein;

FIG. 3 schematically depicts a perspective view of the frame of FIG. 2 mounted to a chassis of the vehicle, according to one or more embodiments shown and described herein;

FIG. 4 schematically depicts a perspective view of the frame of FIG. 2 mounted to the seatback bolster, according to one or more embodiments shown and described herein; and

FIG. 5 schematically depicts a perspective view of the frame of FIG. 2 mounted to the seatback bolster and the belt guide, according to one or more embodiments shown and described herein.

### DETAILED DESCRIPTION

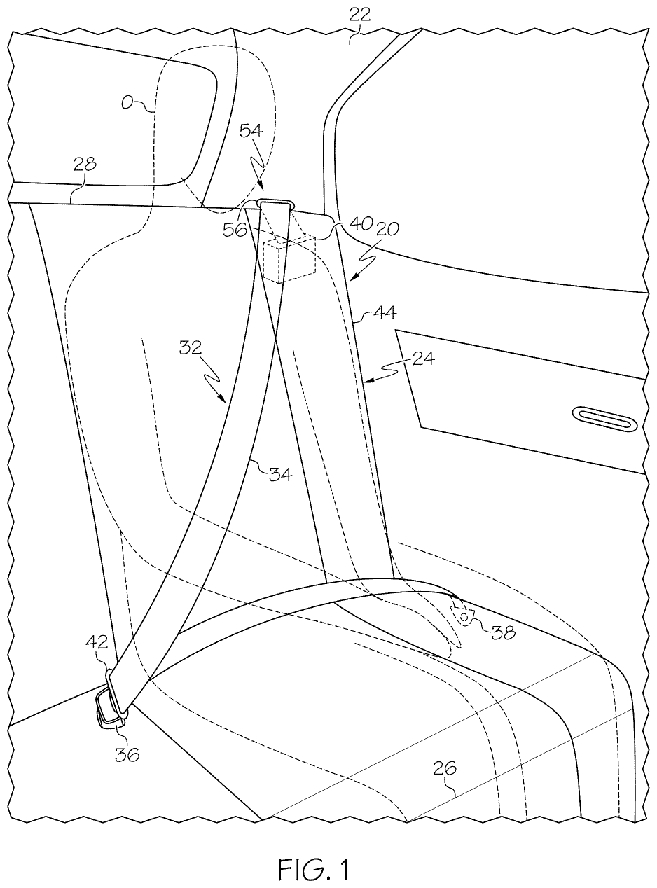

FIG. 1 generally depicts a seatback bolster assembly for a vehicle. The seatback bolster assembly includes a frame having a mounting section configured to be fixed to a chassis of the vehicle and an attachment section fixed to the mounting section. The seatback bolster assembly further includes a seatback bolster configured to support an occupant of the vehicle. The attachment section is mounted to the seatback bolster for supporting the seatback bolster relative to the chassis. The seatback bolster assembly further includes a belt guide defining an aperture for retaining a seatbelt therein and guiding movement of the seatbelt. The belt guide is fixed to the attachment section of the frame through the seatback bolster.

Previous seatback bolster assemblies utilize attachment mechanisms that are susceptible to deflection when the belt guide becomes loaded during a crash event. The deflection of the attachment mechanism and the subsequent movement of the belt guide causes the seatbelt to move in the lateral direction, which in-turn causes the seatbelt to slide up the occupant's chest and not achieve a desired belt position target for ideal occupant restraint. The embodiments described herein overcome these limitations by utilizing the frame, which restrains motion of the seatback bolster and the belt guide during a vehicle event. Various embodiments and benefits of the seatback bolster assembly, and the operation of the seatback bolster assembly, will be described in more detail herein.

Referring now to FIG. 1, a seatback bolster assembly 20 for a vehicle 22, in accordance with one or more embodiments of the present disclosure, is shown. The seatback bolster assembly 20 may form a portion of a seat 24 of the vehicle 22, for supporting an occupant O thereon. More specifically, the seat 24 may include a pan 26 and a seatback 28, with the seatback 28 including the seatback bolster assembly 20. The seatback bolster assembly 20 may form an edge of the seatback 28. The seatback bolster assembly 20 may extend outwardly further than a remainder of the seatback 28 to partially surround the occupant O and thus support the occupant O laterally across the vehicle 22 (e.g., left to right across the vehicle 22).

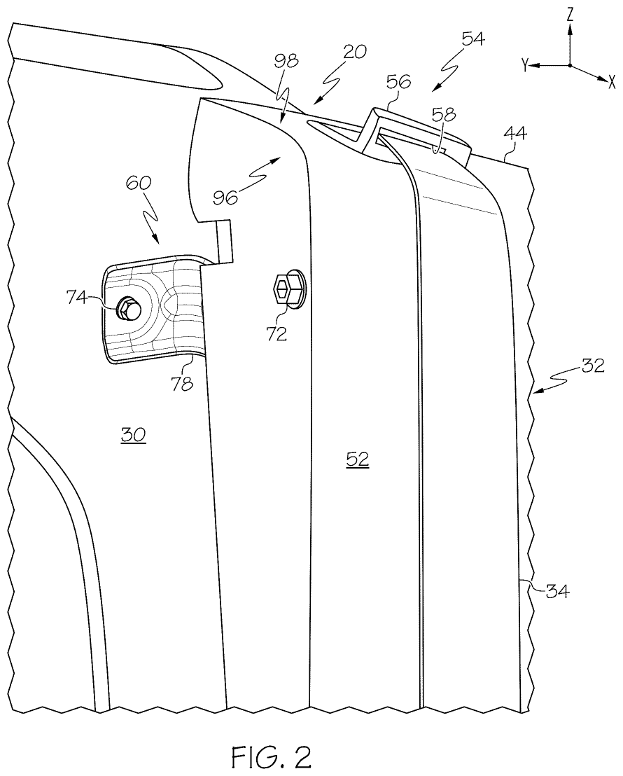

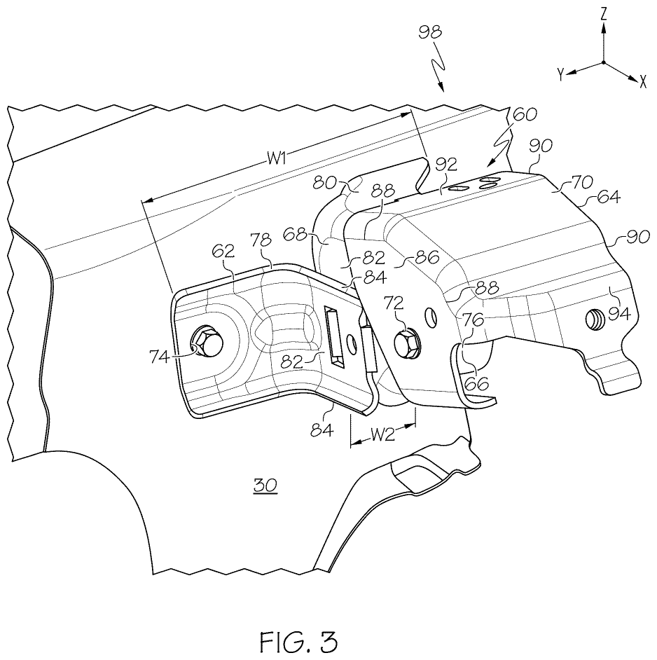

The vehicle 22 may include a chassis 30 that forms the rigid structure of the vehicle 22, as shown in FIGS. 2 and 3. The chassis 30 may be formed from one or more of a frame, subframe, monocoque, unibody, body panels, door(s), trunk lid, hood, etc. The seatback bolster assembly 20 may be fixed to the chassis 30, as will be described in greater detail below.

As shown in FIG. 1, the vehicle 22 may further include a seatbelt 32 for use with the seat 24. More specifically, the seatbelt 32 may include a belt webbing 34 that is fixed to the vehicle 22 and configured to selectively extend across the occupant O disposed within the seat 24 of the vehicle 22. The belt webbing 34 may have a tensile strength suitable for retaining the occupant O within the seat 24 during a vehicle event. The vehicle event may include any acceleration of the vehicle 22 that causes the occupant O to move relative to the seat 24. The vehicle event may include, but is not limited to, aggressive braking and handling, impact with another object, and a vehicle rollover. The belt webbing 34 may be flexible to allow ingress and egress of the occupant O relative to the seat 24 and to accommodate contours of the occupant O and movement of the occupant O. The seatbelt 32 may include a buckle 36 disposed adjacent the pan 26 and an anchor 38 disposed adjacent the pan 26 and opposite the buckle 36. The anchor 38 may be mounted to an end of the belt webbing 34 and fixed to the chassis 30. The seatbelt 32 may further include a retractor 40 disposed adjacent the seatback 28 and fixed to the chassis 30. The belt webbing 34 may be mounted to the retractor 40 at an end opposite the anchor 38, with the retractor 40 configured to selectively wrap the belt webbing 34 therearound. The seatbelt 32 may include a tongue 42 disposed on the belt bet webbing between the anchor 38 and the retractor 40, with the tongue 42 configured to selectively couple with the buckle 36. The belt webbing 34 may selectively unwind from the retractor 40 to allow the belt webbing 34 to extend across the seat 24 and engage the tongue 42 with the buckle 36. In doing so, the seatbelt 32 selectively traverses the occupant O forming a barrier to reduce movement of the occupant O relative to the vehicle 22 during the vehicle event.

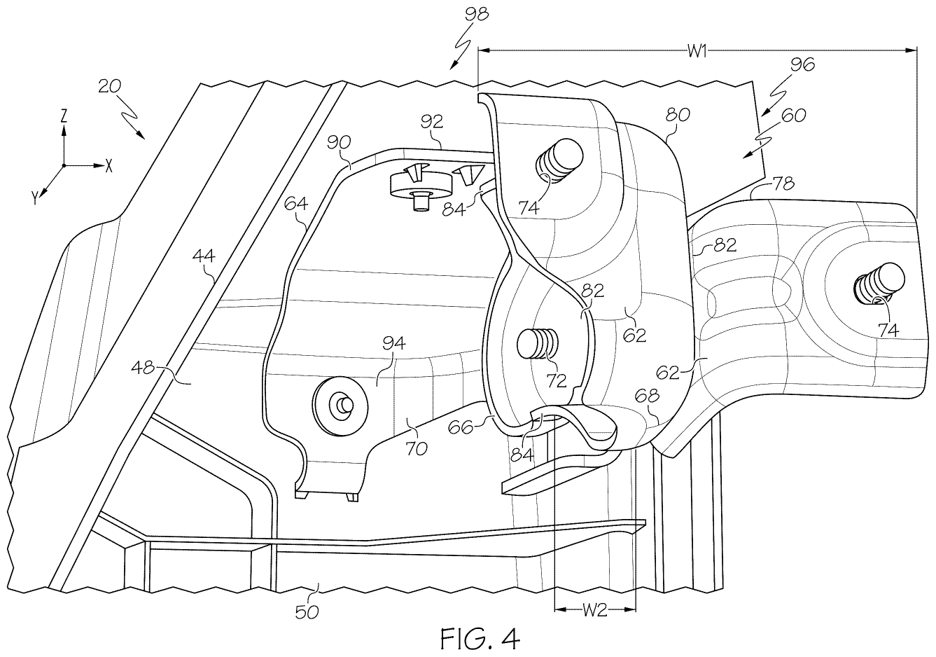

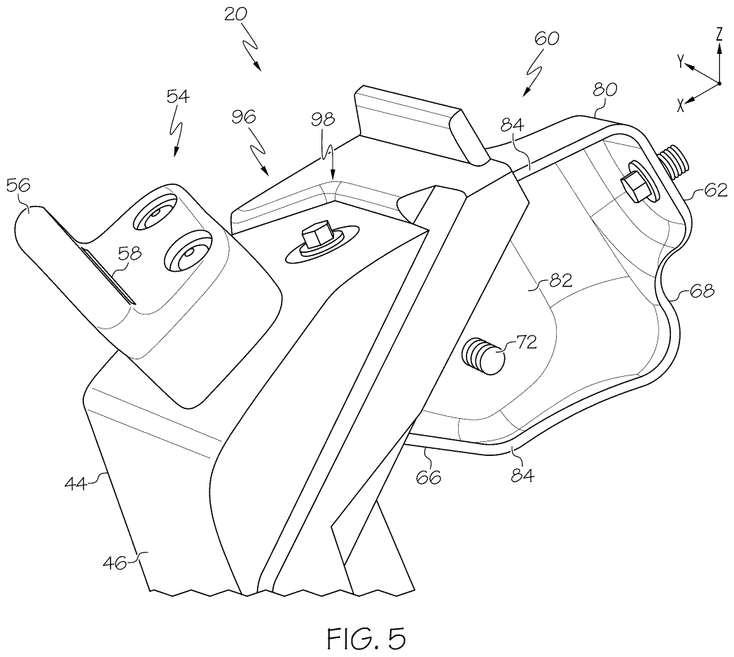

As shown in FIGS. 4 and 5, the seatback bolster assembly 20 may include a seatback bolster 44 having an external surface 46 configured to support the occupant O of the vehicle 22 and an internal surface 48, disposed opposite the external surface 46, and defining a cavity 50. The seatback bolster 44 may be formed from a metal, a polymer, a composite, or any other material having a strength sufficient for supporting the occupant O. The seatback bolster assembly 20 may further include a cushion 52 disposed on the external surface 46 of the seatback bolster 44 for supporting the occupant O of the vehicle 22, as shown in FIG. 2. More specifically, the cushion 52 may provide a soft surface that comfortably supports and positions the occupant O. The cushion 52 may include a foam disposed along the external surface 46 of the bolster and a cover disposed over the foam such that foam is positioned between the seatback bolster 44 and the cover. The cushion 52 may be formed from polyurethane, polyester, or any other material suitable for comfortably supporting the occupant O. The cover may be formed from fabric, leather, vinyl, or any other material suitable for covering the foam.

The seatback bolster assembly 20 may include a support assembly 54. The support assembly 54 may include a belt guide 56 defining an aperture 58 for retaining the seatbelt 32 therein and guiding movement of the seatbelt 32. The belt guide 56 may be positioned along the belt webbing 34 between the retractor 40 and the tongue 42. In the embodiment shown in FIG. 1, the belt guide 56 is positioned on top of the seatback bolster 44. The belt guide 56 positions a portion of the belt webbing 34 extending between the buckle 36 and the retractor 40 such that the belt webbing 34 crosses the chest of the occupant O. In one embodiment, the belt guide 56 is formed from a metal. In another embodiment, the belt guide 56 is formed from a metal that is overmolded with a polymer. It is to be appreciated that the belt guide 56 may be formed of any material suitable for retaining the seatbelt 32 therein and guiding movement of the seatbelt 32.

As shown in FIGS. 3-5, the support assembly 54 may include a frame 60 for supporting the seatback bolster 44 of the vehicle 22. The frame 60 may have a mounting section 62 fixed to the chassis 30 of the vehicle 22, an attachment section 64 fixed to the mounting section 62 and configured to be at least partially disposed within and mounted to the seatback bolster 44 for supporting the seatback bolster 44 relative to the chassis 30, and an interface section 66 between the mounting section 62 and the attachment section 64. More specifically, the frame 60 may include a first bracket 68 having the mounting section 62 and the interface section 66 extending from the mounting section 62 away from the chassis 30. The frame 60 may further include a second bracket 70 having the attachment section 64. The frame 60 may further include a fastener 72 that engages the interface section 66 of the first bracket 68 and the second bracket 70 to fix the first bracket 68 with the second bracket 70. The fastener 72 rigidly connects the first bracket 68 with the second bracket 70, allowing both the first bracket 68 and the second bracket 70 to be fixed to the chassis 30. In the embodiment shown in FIGS. 3-5, the fastener 72 is a bolt. However, the fastener 72 may be a machine screw, a rivet, or any other component that mechanically connects the first bracket 68 with the second bracket 70.

The mounting section 62 may extend in a lateral direction Y along the chassis 30 and the frame 60 may extend along a longitudinal direction X, transverse to the lateral direction Y, to the attachment section 64. More specifically, the mounting section 62 may extend in the lateral direction Y along the chassis 30 and the interface section 66 may extend from the mounting section 62 in the longitudinal direction X that is transverse to the lateral direction Y. In the embodiment shown in FIGS. 2-5, the longitudinal direction X is orthogonal to the lateral direction Y. However, the longitudinal direction X may be disposed at any suitable angle relative to the lateral direction Y. Furthermore, in this embodiment, the lateral direction Y is positioned cross-car (e.g., left-right across the vehicle 22) and the longitudinal direction X is positioned lengthwise along the vehicle 22 (e.g., fore-aft along the vehicle 22). However, the terms “lateral direction” and “longitudinal direction” are not indicative of the shape and positioning of the vehicle 22 itself and may be used in any position within the vehicle 22.

In the embodiment shown in FIG. 4, the mounting section 62 defines a pair of mounting holes 74 spaced from one another and aligned along the lateral direction Y. The pair of mounting holes 74 may be configured to each receive a fastener (e.g., a bolt or a machine screw) for fixing the frame 60 to the chassis 30. It is to be appreciated that the mounting section 62 may include any number of mounting holes 74 for fixing the frame 60 to the chassis 30. It is also to be appreciated that the mounting section 62 may be fixed to the chassis 30 by welding, chemical bonding, or in any other suitable manner.

As shown in FIGS. 3 and 4, the mounting section 62 defines a first width W1 in the lateral direction Y and the interface section 66 defines a second width W2 in the lateral direction Y. The second width W2 may be less than the first width W1 of the mounting section 62. As such, the mounting section 62 may be considered to be a flange that extends along the chassis 30 to support the frame 60 (e.g., the interface section 66 and the attachment section 64). In extending along the chassis 30 and in the lateral direction Y, the mounting section 62 presents a large footprint along the chassis 30 that rigidly supports the frame 60 and rotation and flexing of the frame 60 about the mounting section 62 and reduced movement of the belt guide 56. More specifically, loading on the interface section 66 and/or the attachment section 64 may produce a moment that is exerted on the engagement of the mounting section 62 with the chassis 30. The first width W1 being greater than the second width W2 provides a rigid base for the frame 60 to reduce rotation and flexing about the mounting section 62.

As shown in FIG. 3, the interface section 66 may have an engagement surface 76 that abuts the second bracket 70 at the fastener 72, with the engagement surface 76 having a planar configuration that is transverse to the lateral direction Y. In the embodiment shown in FIG. 3, the engagement surface 76 is orthogonal to the lateral direction Y. More specifically, the planar configuration of the engagement surface 76 extends in the longitudinal direction X and in a vertical direction Z, which is orthogonal to both the longitudinal direction X and the lateral direction Y. The planar configuration of the engagement surface 76 provides contact between the first bracket 68 and the second bracket 70 around the fastener 72, which produces friction therebetween. The friction at the engagement surface 76 produces a rigid connection between the first bracket 68 and the second bracket 70, which fixes the second bracket 70 relative to the chassis 30.

As shown in FIGS. 3 and 4, the first bracket 68 may include a first brace 78 and a second brace 80 each having an L-shape configuration. Accordingly, a portion of each of the first brace 78 and the second brace 80 may lie along one another in the longitudinal direction X to collectively define the interface section 66, and a portion of each of the first brace 78 and the second brace 80 may extend away from one another in the lateral direction Y to collectively define the mounting section 62. In one embodiment, the first brace 78 and the second brace 80 are fixed to one another along the interface section 66 by welding. However, the first brace 78 and the second brace 80 may be fixed to one another along the interface section 66 by chemical bonding, mechanical fastening, or in any other suitable manner. The first brace 78 and the second brace 80 may be formed by one or more production methods, including stamping, rolling, drilling, milling, etc. In other embodiments, the first bracket 68 may formed from a single monolithic construction formed by additive manufacturing, CNC machining, etc. It is to be appreciated that the first bracket 68 may be formed from any number of braces or other components.

The interface section 66 may have an I-beam configuration. More specifically, in the embodiment shown in FIGS. 3-5, each of the first brace 78 and the second brace 80 have a body 82 having a substantially planar configuration extending in the longitudinal direction X and the vertical direction Z and a pair of shoulders 84 disposed on opposing sides the body 82 along the vertical direction Z. The shoulders 84 have substantially planar configurations extending in the lateral direction Y and the longitudinal direction X. The shoulders 84 of the first brace 78 extend away from the shoulders 84 of the second brace 80. Accordingly, the body 82 and the shoulders 84 of the first brace 78 and the second brace 80 have the I-beam configuration in cross-section through the interface section 66. The I-beam configuration of the interface section 66 provides an area moment of inertia that provides rigidity and resistance to deflection, bending, and stress therein. It is to be appreciated that the interface section 66 may have any suitable shape and configuration for supporting the attachment section 64 relative to the mounting section 62.

The attachment section 64 may be at least partially disposed within the cavity 50 and mounted to the internal surface 48 of the seatback bolster 44 for supporting the seatback bolster 44 relative to the chassis 30. The attachment section 64 is shaped to nest within the cavity 50 of the seatback bolster 44 and lie along the internal surface 48. More specifically, the attachment section 64 of the second bracket 70 may include a first wall 86 having a planar configuration and extending in the longitudinal direction X and the vertical direction Z to a perimeter edge 88, as shown in FIG. 3. The attachment section 64 of the second bracket 70 may further include a second wall 90 extending transverse to the first wall 86 along the perimeter edge 88. In the embodiment shown in FIG. 3, the second wall 90 of the attachment section 64 extends orthogonal to the first wall 86. The second wall 90 includes a first portion 92 that extends from the perimeter edge 88 in a planar configuration along the lateral direction Y and the longitudinal direction X. The second wall 90 further includes a second portion 94 that extends from the perimeter edge 88 in a planar configuration along the lateral direction Y and the vertical direction Z. The second wall 90 bends in transition between the first portion 92 and the second portion 94. The dispositions of the first wall 86 and the second wall 90 are configured to nest within a corner 96 of the seatback bolster 44 within the cavity 50 (e.g., an upper corner of the seatback bolster 44) provide rigidity to the corner 96 of the seatback bolster 44. However, the first wall 86 and the second wall 90 may have any configuration for supporting any portion of the seatback bolster 44. In the embodiment shown in FIG. 4, the attachment section 64 is mounted to the seatback bolster 44 by push-pin fasteners. However, the attachment section 64 may be mounted to the seatback bolster 44 by rivets, screws, bolts, chemical bonding, welding, or any other suitable manner of connection.

In the embodiment shown in FIG. 5, the belt guide 56 is fixed to the attachment section 64 of the frame 60. More specifically, the belt guide 56 is disposed on the external surface 46 of the seatback bolster 44 and is fixed to the attachment section 64 of the frame 60 through the seatback bolster 44. In the embodiment shown in FIG. 5, the belt guide 56 is disposed on a top portion 98 of the attachment section 64 of the frame 60. As described above, the top portion 98 of the attachment section 64 refers to the first portion 92 of the second wall 90. Accordingly, the belt guide 56 may be fixed to the first portion 92 of the second wall 90 of the attachment section 64. The disposition of the belt guide 56 on top of the attachment section 64 and the seatback bolster 44 positions the belt guide 56 above a shoulder of the occupant O, which allows the belt webbing 34 to cross the chest of the occupant O. It is to be appreciated that the belt guide 56 may be positioned along any portion of the seatback bolster 44 and may be fixed to any portion of the attachment section 64.

As described above, the mounting section 62 may define the first width W1 in the lateral direction Y. The belt guide 56 may be fixed to the attachment section 64 of the frame 60 within a region aligned with the first width W1 along longitudinal direction X and bounded by the first width W1 in the lateral direction Y. In doing so, the belt guide 56 is aligned longitudinally with the frame 60, which reduces moments on the frame 60 about the mounting portion, which would increase deflection.

To assemble the seatback bolster assembly 20 in the vehicle 22, the first bracket 68 is independently mounted to the chassis 30. The second bracket 70 is mounted to the seatback bolster 44 and the belt guide 56 is mounted to the second bracket 70 through the seatback bolster 44. The second bracket 70 is then positioned on the first bracket 68 and is assembled to the first bracket 68 by insertion of the fastener 72.

It should now be understood that embodiments of the present disclosure are directed to a seatback bolster assembly for a vehicle. The seatback bolster assembly includes a frame having a mounting section configured to be fixed to a chassis of the vehicle and an attachment section fixed to the mounting section. The seatback bolster assembly further includes a seatback bolster configured to support an occupant of the vehicle. The attachment section is mounted to the seatback bolster for supporting the seatback bolster relative to the chassis. The seatback bolster assembly further includes a belt guide defining an aperture for retaining a seatbelt therein and guiding movement of the seatbelt. The belt guide is fixed to the attachment section of the frame through the seatback bolster. The utilization of the frame restrains motion of the seatback bolster and the belt guide during a vehicle event. More specifically, the fastener connecting the first bracket of the frame with the second bracket of the frame provides a rigid connection therebetween. Taken in conjunction with the mounting of the first bracket to the chassis and the second bracket to the seatback bolster, the fastener provides a simple and quick way to fix the seatback bolster to the chassis. Moreover, the mounting section of the frame extending in the lateral direction and having the first width that is greater than the second width of the interface section provides a rigid base for the frame to reduce rotation and flexing about the mounting section. As such, movement of the belt guide is reduced in comparison to other seatback bolster assemblies, which better maintains the position of the belt webbing across the chest of the occupant.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A frame for supporting a seatback bolster of a vehicle, the frame comprising:
a first bracket having a mounting section configured to be fixed to a chassis of the vehicle, and an interface section extending from the mounting section away from the chassis;
a second bracket configured to be at least partially disposed within and mounted to the seatback bolster; and
a fastener that engages the interface section of the first bracket and the second bracket to fix the first bracket with the second bracket.

2. The frame of claim 1, wherein the mounting section extends in a lateral direction along the chassis and the interface section extends from the mounting section in a longitudinal direction that is transverse to the lateral direction.

3. The frame of claim 1, wherein the mounting section defines a first width in the lateral direction, and wherein the interface section defines a second width in the lateral direction that is less than the first width of the mounting section.

4. The frame of claim 2, wherein the interface section has an engagement surface that abuts the second bracket at the fastener, with the engagement surface having a planar configuration that is transverse to the lateral direction.

5. The frame of claim 1, wherein the first bracket comprises a first brace and a second brace each having an L-shape configuration, wherein a portion of each of the first brace and the second brace lie along one another in the longitudinal direction to collectively define the interface section, and wherein a portion of each of the first brace and the second brace extend away from one another in lateral direction to collectively define the mounting section.

6. The frame of claim 1, wherein the interface section has an I-beam configuration.

7. The frame of claim 1, wherein the second bracket comprises:
a first wall having a planar configuration and extending in the longitudinal direction to a perimeter edge; and
a second wall extending transverse to the first wall along the perimeter edge.

8. A support assembly for a seatback bolster and a seatbelt of a vehicle, the support assembly comprising:
a frame having a mounting section configured to be fixed to a chassis of the vehicle and an attachment section fixed to the mounting section and configured to be at least partially disposed within and mounted to the seatback bolster for supporting the seatback bolster relative to the chassis; and
a belt guide defining an aperture for retaining the seatbelt therein and guiding movement of the seatbelt, wherein the belt guide is fixed to the attachment section of the frame.

9. The support assembly of claim 8, wherein the belt guide is disposed on a top portion of the attachment section of the frame.

10. The support assembly of claim 8, wherein the mounting section extends in a lateral direction along the chassis and the frame extends along a longitudinal direction, transverse to the lateral direction, to the attachment section.

11. The support assembly of claim 10, wherein the mounting section defines a first width in the lateral direction, with the belt guide fixed to the attachment section of the frame within a region aligned with the first width along longitudinal direction and bounded by the first width in the lateral direction.

12. The support assembly of claim 8, wherein the frame comprises an interface section between the mounting section and the attachment section, with the interface section having an I-beam configuration.

13. The support assembly of claim 12, wherein the mounting section defines a first width in the lateral direction, and wherein the interface section defines a second width in the lateral direction that is less than the first width of the mounting section.

14. The support assembly of claim 12, wherein the frame comprises a first bracket having the mounting section and the interface section, a second bracket having the attachment section, and a fastener that engages the interface section of the first bracket and the second bracket to fix the first bracket with the second bracket.

15. The support assembly of claim 14, wherein the interface section has an engagement surface that abuts the second bracket at the fastener, with the engagement surface having a planar configuration.

16. A seatback bolster assembly for a vehicle, the seatback bolster assembly comprising:
a frame having a mounting section configured to be fixed to a chassis of the vehicle and an attachment section fixed to the mounting section;
a seatback bolster having an external surface configured to support an occupant of the vehicle and an internal surface, disposed opposite the external surface, and defining a cavity, with the attachment section at least partially disposed within the cavity and mounted to the internal surface of the seatback bolster for supporting the seatback bolster relative to the chassis; and
a belt guide defining an aperture for retaining a seatbelt therein and guiding movement of the seatbelt, wherein the belt guide is disposed on the external surface of the seatback bolster and is fixed to the attachment section of the frame through the seatback bolster.

17. The seatback bolster assembly of claim 16, wherein the attachment section of the frame is shaped to nest within the cavity of the seatback bolster and lie along the internal surface.

18. The seatback bolster assembly of claim 16, wherein the attachment section of the frame comprises:
a first wall having a planar configuration and extending in a longitudinal direction to a perimeter edge; and
a second wall extending transverse to the first wall along the perimeter edge.

19. The seatback bolster assembly of claim 18, wherein the belt guide is fixed to the second wall of the attachment section of the frame.

20. The seatback bolster assembly of claim 16, further comprising a cushion disposed on the external surface of the bolster for supporting an occupant of the vehicle.
